(19) United States
(12) Patent Application Publication
(10) Pub. No.: US 2009/0184525 A1
(43) Pub. Date: Jul. 23, 2009

(54) ELECTRONIC DEVICE AND LATCH STRUCTURE THEREOF

(75) Inventor: Chen TSENG, Tao Yuan Shien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: QUANTA COMPUTER INC., Tao Yuan Shien (TW)

(21) Appl. No.: 12/133,767

(22) Filed: Jun. 5, 2008

(30) Foreign Application Priority Data
Jan. 18, 2008 (TW) 97101975

(51) Int. Cl. E05C 9/00

(52) U.S. Cl. 292/300

(57) ABSTRACT

A latch structure is disclosed, including a base, a first element disposed on the base and having a first guiding portion with a driving surface thereon, a second element having a second guiding portion, and a latching element driven by the second element. The first element disposed on the base moves between a first reference position and a second reference position with respect to a first axis. The driving surface of the first guiding portion is extended along a reference axis passing through the first axis. The second element moves between a first predetermined position and a second predetermined position with respect to a second axis. The second guiding portion of the second element guided by the first guiding portion of the first element is movably contacted by the driving surface thereon. The latching element driven by the second element is moved between a latching position and an unlatching position.

### CROSS REFERENCE TO RELATED APPLICATIONS

This Application claims priority of Taiwan Patent Application No. 097101975, filed on Jan. 18, 2008, the entirety of which is incorporated by reference herein.

### BACKGROUND OF THE INVENTION

1. Field of the Invention

The invention relates to an electronic device, and more particularly to an electronic device and a latch structure thereof.

2. Description of the Related Art

Electronic devices, such as laptops, are provided with a latch to connect two objects, such as a host and panel of the laptop. A conventional latch is a sliding button which transversely moves to connect or disconnect the panel to the host.

### BRIEF SUMMARY OF THE INVENTION

The invention provides a simple push-on latch structure to facilitate the connection or disconnection of two objects. An embodiment of the latch structure comprises a base, a first element, a second element and a latching element. The first element, disposed on the base and moved between a first reference position and a second reference position with respect to a first axis, comprises a first guiding portion formed with a driving surface, wherein the driving surface of the first guiding portion extends along a reference axis passing through the first axis. The second element, moved between a first predetermined position and a second predetermined position with respect to a second axis, comprises a second guiding portion guided by the first guiding portion of the first element, and the driving surface of the first guiding portion movably contacts the second element. The latching element driven by the second element moves between a latching position and an unlatching position.

When the first element is moved from the first reference position toward the second reference position, the driving surface of the first guiding portion is abuttedly pressed against the second guiding portion of the second element and the second element is moved from the first predetermined position toward the second predetermined position, thus, driving the latching element to move from the latching position toward the unlatching position. When the first element is moved to the second reference position, the first guiding portion of the first element makes way for the second guiding portion of the second element and lets the second element move to the second predetermined position, thus, the latching element driven by the second element is moved from the latching position to the unlatching position.

Further, the invention provides an electronic device with a latch structure. The electronic device comprises a first body, a second body pivoted to the first body, and a latching structure disposed between the first body and the second body. The latching structure comprises a first element, a second element and a latching element. The first element, disposed on the second body and moved between a first reference position and a second reference position with respect to a first axis, comprises a first guiding portion formed with a driving surface, wherein the driving surface of the first guiding portion extends along a reference axis passing through the first axis. The second element, moved between a first predetermined position and a second predetermined position with respect to a second axis, comprises a second guiding portion guided by the first guiding portion of the first element, and the driving surface of the first guiding portion movably contacts the second element. The latching element, driven by the second element to detachably engage with the first body, is moved between a latching position and an unlatching position.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a perspective view of an electronic device situated in a closed state of the invention;

FIG. 1B is a perspective view of the electronic device of FIG. 1A, where the electronic device is in an open state of the invention;

FIG. 2A is a perspective inversed view of an electronic device of FIG. 1A;

FIG. 2B is a perspective inversed view of an electronic device of FIG. 1B;

FIG. 3A is a schematic view of the electronic device partially sectioned from line (C1-C1) in FIG. 2A, where a latch structure is situated in a latching position;

FIG. 3B is a schematic view of the electronic device partially sectioned from line (C2-C2) in FIG. 2B, where a latch structure is situated in an unlatching position;

FIG. 4A is a perspective view of the latch structure of the invention viewed from another observed angle; and

FIG. 4B is an enlarged view of region (R) in FIG. 4A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

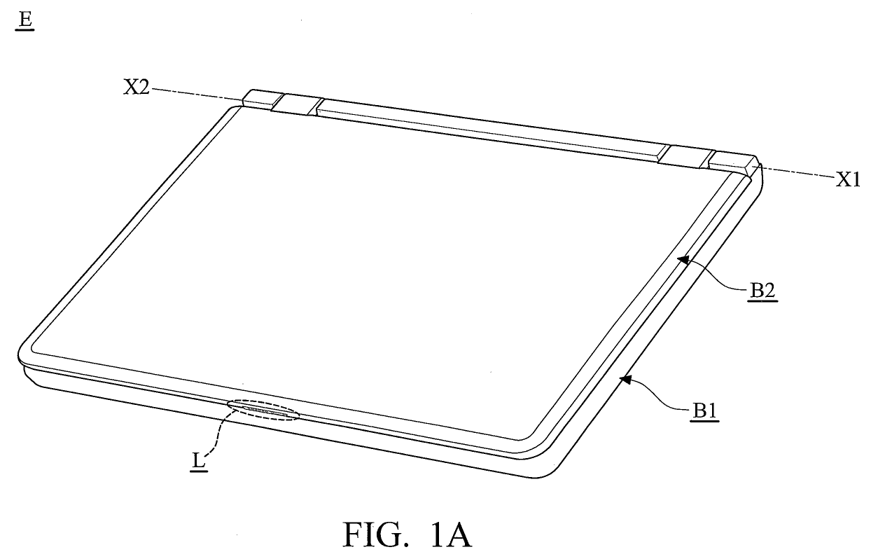

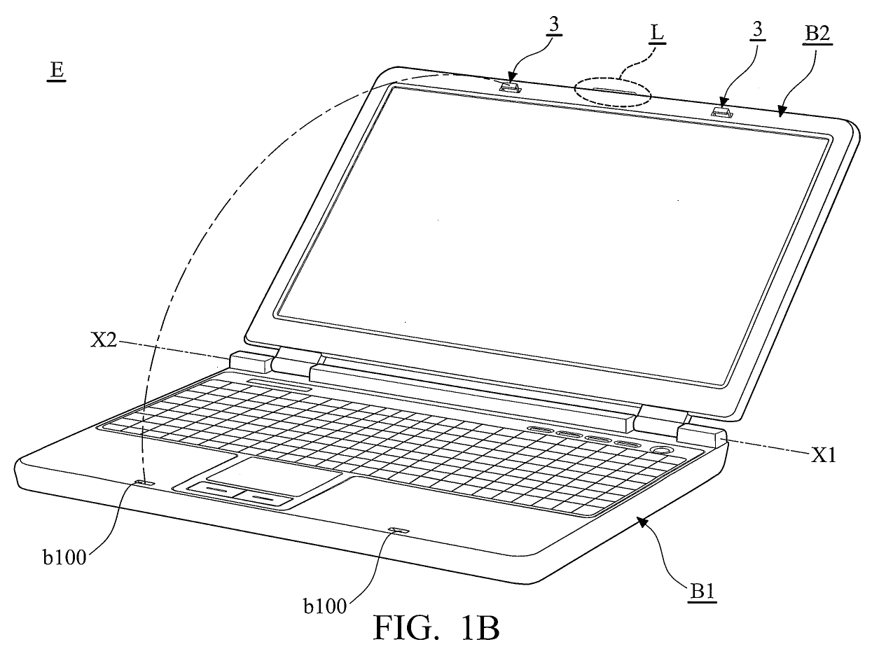

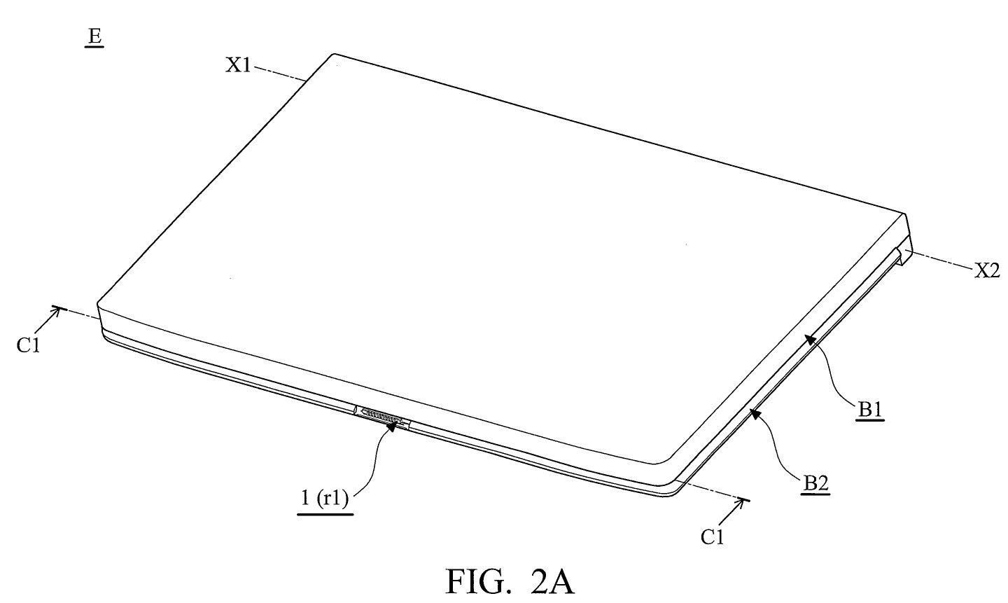

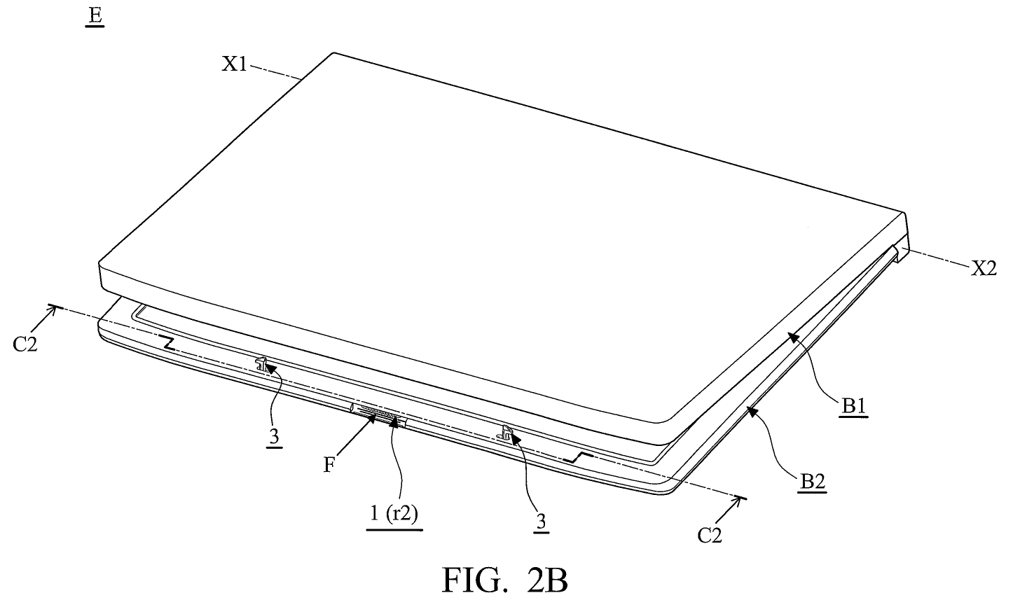

FIGS. 1A and 1B are perspective views showing an electronic device E situated in a closed state and an open state, respectively. FIGS. 2A and 2B are perspective inversed views showing an electronic device E of FIGS. 1A and 1B, respectively.

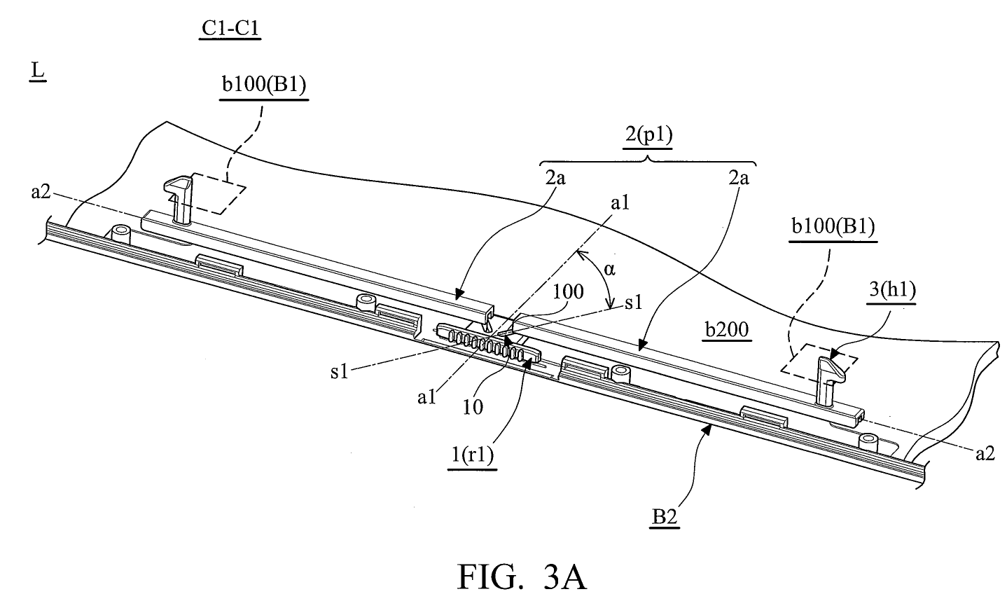

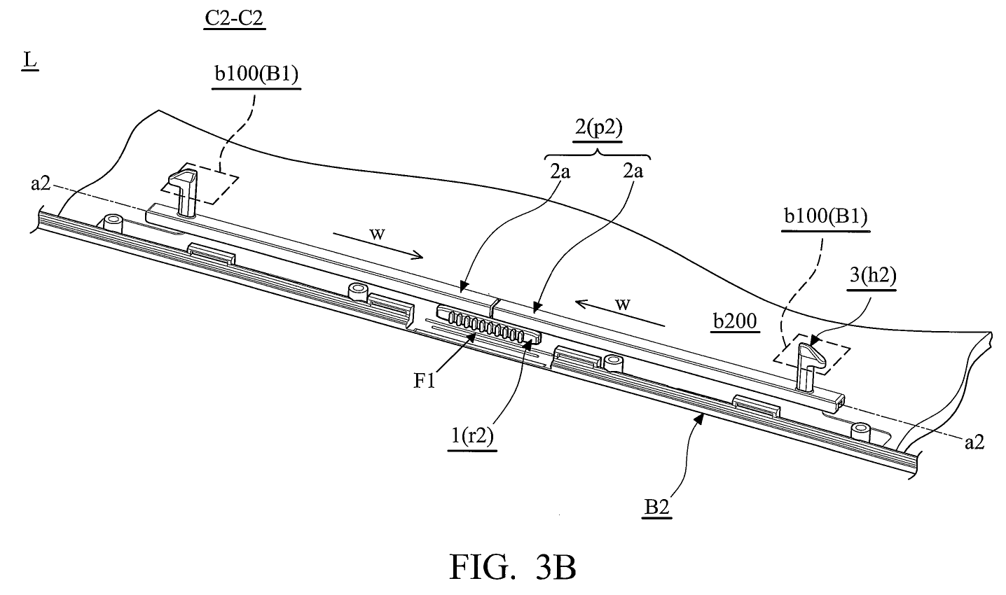

The electronic device E comprises a first body B1, a second body B2, and a latching structure L disposed between the first body B1 and the second body B2. The second body B2 at one side thereof is pivoted to the first body B1 about an axis X1-X2, and the second body B2 at another side thereof is detachably disposed at the first body B1 via the latching structure L. In FIG. 1B, the first body B1 comprises two positioning portions b100, and the second body B2 comprises a base b200 (see FIG. 3A) and two latching elements 3 respectively corresponding to the positioning portions b100 of the first body B1. In this embodiment, the electronic device E is a laptop, wherein the first body B1 is a host of the laptop, the second body B2 is a panel such as an LCD of the laptop, the latching structure L is disposed on the second body B2, and the positioning portions b100 of the first body B1 are positioning holes. In other embodiments, an inverse arrangement can be achieved by disposing the latching structure at the first body and disposing the positioning portions at the second body.

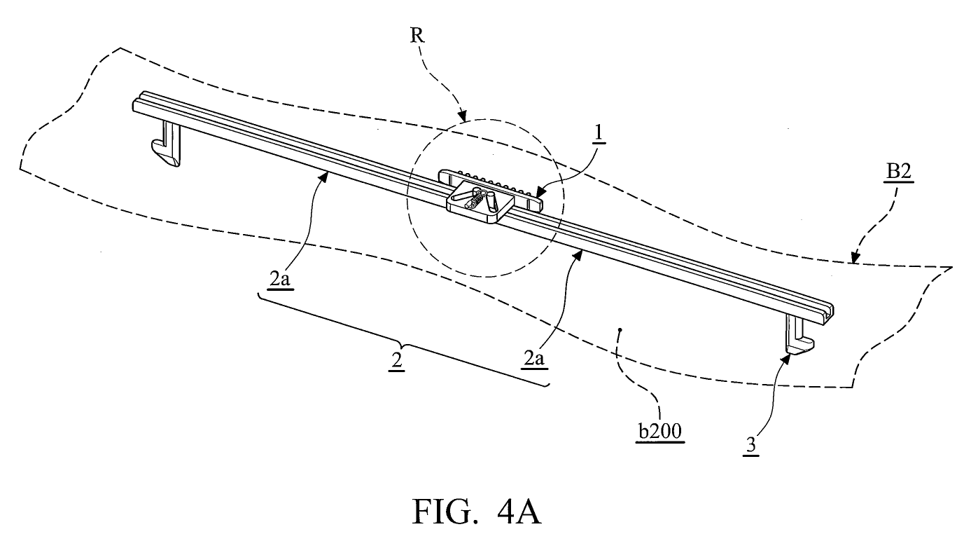

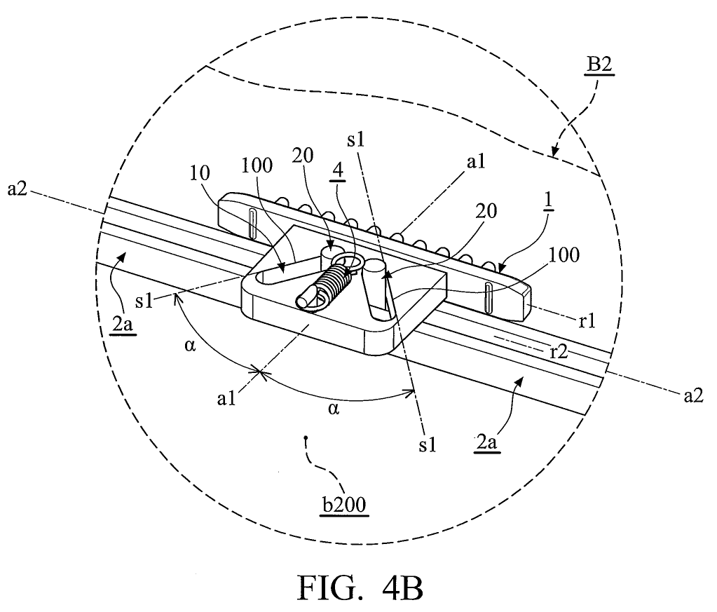

FIG. 3A is a schematic view of the electronic device E partially sectioned from line C1-C1 in FIG. 2A, where the latch structure L is situated in a latching position. FIG. 3B is a schematic view of the electronic device E partially sectioned from line C2-C2 in FIG. 2B, where the latch structure L is situated in an unlatching position. FIG. 4A is a perspective view of the latch structure L viewed from another observed angle, and FIG. 4B is an enlarged view of a region R in FIG. 4A.

Referring to FIGS. 3A and 4B, the latching structure L comprises a first element 1 disposed on the second body B2, a second element 2, a recovering element 4 and the latching elements 3. The first element 1 is a returnable slider, reciprocally moving between a first reference position r1 (an initial position) and a second reference position r2 (see FIG. 3B) with respect to a first axis a1-a1. The first element 1 comprises two first guiding portions 10, and each of which is formed with a driving surface 100 thereon. The driving surface 100 of the first guiding portion 10 extends along a reference axis s1-s1 passing through the first axis a1-a1.

The second element 2 moves between a first predetermined position p1 and a second predetermined position p2 with respect to a second axis a2-a2, and the first axis a1-a1 is different from the second axis a2-a2. The second element 2 comprises two halves 2a movably disposed on the base b200 of the second body B2. Each half 2a comprises a second guiding portion 20 guided by the first guiding portion 10 of the first element 1, and the driving surface 100 of the first guiding portion 10 movably contacts the second element 2. In this embodiment, the first axis a1-a1 and the second axis a2-a2 are perpendicular to each other, the reference axis s1-s1 corresponding to the driving surface 100 is a straight axis, and an angle α is formed between the straight axis and the first axis a1-a1. The first guiding portion 10 of the first element 1 is a slotted structure, the driving surface 100 is an inner sidewall of the slotted structure, and the second guiding portion 20 of the second element 2 is a protrusion.

The latching element 3, driven by the second element 2 to detachably engage with the first body B1, is moved between a latching position h1 (closed state) and an unlatching position h2 (open state), thereby connecting to or separating from the positioning portion b100 of the first body B1. In this embodiment, the latching element 3 is a hook integrally formed on the second element 2, and the hook is capable of engaging with the positioning portion b100 of the first body B1.

In FIG. 4B, the recovering element 4 is disposed between the base b200 and the first element 1. The first element 1 moves between the first reference position r1 and the second reference position r2 via the recovering element 4. In this embodiment, the recovering element 4 is a spring.

When the first element 1 is located at the first reference position r1, shown in FIGS. 2A and 3A, the second element 2 is located at the first predetermined position p1, and the latching element 3 is located at the latching position h1 and is engaged with the first body B1. When an external force F1 is pressed on the first element 1 of the electronic device E, shown in FIGS. 2B and 3B, the first element 1 is moved from the first reference position r1 toward the second reference position r2, and the driving surface 100 of the first guiding portion 10 is abuttedly pressed against the second guiding portion 20 of the second element 2 and the second element 2 is moved from the first predetermined position p1 toward the second predetermined position p2, i.e., the halves 2a approach to each other along direction w. Thus, the latching element 3 is driven to move from the latching position h1 toward the unlatching position h2.

When the first element 1 is moved to the second reference position r2, shown in FIG. 3B, the first guiding portion 10 of the first element 1 makes way for the second guiding portion 20 of the second element 2 and lets the second element 2 move to the second predetermined position p2, and the latching element 3 driven by the halves 2a of the second element 2 is moved from the latching position h1 to the unlatching position h2, separating the latching element 3 from the first element 1, i.e., the latching element 3 and the positioning portion b100 of the first body B1 are separated. Thus, the second body B2 can be separated from the first body B1.

Based on the described features, it is understood that the operation of opening or closing step of the first and second bodies B1 and B2 of the electronic device E can be facilitated by the push-on latching structure L.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A latch structure, comprising:
a base;
a first element disposed on the base and moved between a first reference position and a second reference position with respect to a first axis, comprising a first guiding portion formed with a driving surface, wherein the driving surface of the first guiding portion extends along a reference axis passing through the first axis;
a second element moved between a first predetermined position and a second predetermined position with respect to a second axis, comprising a second guiding portion guided by the first guiding portion of the first element, and the driving surface of the first guiding portion movably contacts the second element; and
a latching element driven by the second element, moved between a latching position and an unlatching position.

2. The latch structure as claimed in claim 1, wherein when the first element is moved from the first reference position toward the second reference position, the driving surface of the first guiding portion is abuttedly pressed against the second guiding portion of the second element and the second element is moved from the first predetermined position toward the second predetermined position, thus, driving the latching element to move from the latching position toward the unlatching position, and when the first element is moved to the second reference position, the first guiding portion of the first element makes way for the second guiding portion of the second element and lets the second element move to the second predetermined position, thus, the latching element driven by the second element is moved from the latching position to the unlatching position.

3. The latch structure as claimed in claim 1 further comprising a recovering element disposed between the base and the first element.

4. The latch structure as claimed in claim 3, wherein the recovering element comprises a spring.

5. The latch structure as claimed in claim 1, wherein the first axis is different from the second axis.

6. The latch structure as claimed in claim 1, wherein the first axis and the second axis are perpendicular to each other.

7. The latch structure as claimed in claim 1, wherein the reference axis corresponding to the driving surface is a straight axis, and an angle is formed between the straight axis and the first axis.

8. The latch structure as claimed in claim 1, wherein the first guiding portion of the first element is a slotted structure, and the driving surface is an inner sidewall of the slotted structure.

9. The latch structure as claimed in claim 1, wherein the second guiding portion of the second element is a protrusion.

10. The latch structure as claimed in claim 1, wherein the latching element is integrally formed on the second element.

11. An electronic device, comprising:
a first body; a second body pivoted to the first body; and
a latching structure disposed between the first body and the second body, comprising:
a first element disposed on the second body and moved between a first reference position and a second reference position with respect to a first axis, comprising a first guiding portion formed with a driving surface, wherein the driving surface of the first guiding portion extends along a reference axis passing through the first axis;
a second element moved between a first predetermined position and a second predetermined position with respect to a second axis, comprising a second guiding portion guided by the first guiding portion of the first element, and the driving surface of the first guiding portion movably contacts the second element; and
a latching element driven by the second element to detachably engage with the first body, moved between a latching position and an unlatching position.

12. The electronic device as claimed in claim 11, wherein when the first element is located at the first reference position, the latching element is located at the latching position and is engaged with the first body, and when the first element is moved from the first reference position toward the second reference position, the driving surface of the first guiding portion is abuttedly pressed against the second guiding portion of the second element and the second element is moved from the first predetermined position toward the second predetermined position, thus, driving the latching element to move from the latching position toward the unlatching position; and when the first element is moved to the second reference position, the first guiding portion of the first element makes way for the second guiding portion of the second element and lets the second element move to the second predetermined position, and the latching element driven by the second element is moved from the latching position to the unlatching position, thus, separating the latching element from the first element.

13. The electronic device as claimed in claim 12, wherein the latching structure further comprises a recovering element disposed between the base and the first element.

14. The electronic device as claimed in claim 13, wherein the recovering element comprises a spring.

15. The electronic device as claimed in claim 12, wherein the first axis and the second axis are perpendicular to each other.

16. The electronic device as claimed in claim 12, wherein the reference axis corresponding to the driving surface is a straight axis, and an angle is formed between the straight axis and the first axis.

17. The electronic device as claimed in claim 12, wherein the first guiding portion of the first element is a slotted structure, and the driving surface is an inner sidewall of the slotted structure.

18. The electronic device as claimed in claim 12, wherein the second guiding portion of the second element is a protrusion.

19. The electronic device as claimed in claim 12, wherein the latching element is integrally formed on the second element.

20. The electronic device as claimed in claim 12, wherein the electronic device is a laptop.
